(19) United States
(12) Patent Application Publication
(10) Pub. No.: US 2024/0335895 A1
(43) Pub. Date: Oct. 10, 2024

(54) METHOD FOR ELECTROCHEMICALLY MACHINING A WORKPIECE

(71) Applicant: MTU Aero Engines AG, München (DE)

(72) Inventors: Nicole Feiling, Munich (DE); Martin Könitzer, Munich (DE); Gazmen Dzemajili, Munich (DE); Alexander Bogner, Großberghofen (DE); Ferhat Gever, Schwabhausen (DE)

(73) Assignee: MTU Aero Engines AG, München (DE)

(21) Appl. No.: 18/700,055

(22) PCT Filed: Oct. 10, 2022
(86) PCT No.: PCT/DE2022/100745

§ 371 Date: Apr. 10, 2024

(30) Foreign Application Priority Data
Oct. 13, 2021 (DE) 10 2021 126 482.0

(51) Int. Cl. B23H 3/10; B23H 9/10

(52) U.S. Cl. CPC B23H 3/10; B23H 9/10

(57) ABSTRACT

The invention relates to a method for machining a workpiece by an electrochemical machining process in which material is removed from the workpiece in an electrolyte liquid, where the electrolyte liquid is then filtered in a membrane filter system which has a membrane that undergoes a relative movement in the membrane filter system during the filtering process, and the filtered electrolyte liquid is reused for the electrochemical machining process.

### BACKGROUND OF THE INVENTION

The present invention relates to a method for machining a workpiece by electrochemical removal.

In electrochemical removal, a work gap is adjusted between the workpiece and the tool and, typically, the workpiece is then polarized as the anode and the tool as the cathode. Based on the insofar contact-free machining, it is possible to machine even relatively hard materials by electrochemical removal of material, for which reason the method can be used advantageously in the production of components for axial turbomachines, in particular aircraft engines. Against this background, special requirements can also ensue in terms of the precision and reproducibility of the workpiece machining. This is intended to illustrate a preferred area of application, but initially not to limit the present subject in its generality.

### SUMMARY OF THE INVENTION

The present invention is based on the technical problem of specifying an especially advantageous method for machining a workpiece by electrochemical removal.

This problem is solved in accordance with the method of the present invention. An electrolyte liquid, in which the charge transport occurs in the work gap between the tool and the workpiece, is thereby fed to a membrane filter system; that is, the electrolyte liquid is filtered over a membrane and subsequently used once again for the electrochemical machining. The electrolyte liquid is recirculated over the membrane filter system. In the membrane filter system, the electrolyte liquid flows tangentially over the membrane thereof, this being achieved in the present case by a relative movement of the membrane with respect to a wall, for example, which bounds a cavity in which the electrolyte liquid that is to be filtered is introduced upstream of the membrane. Preferably, the relative movement occurs by way of a rotational movement of the membrane (see below in detail). Regardless of the kind of detailed movement, the relative movement makes it possible to achieve, for example, a relatively high permeate flow, that is, a flow of the filtered electrolyte liquid, so that less electrolyte liquid overall is required in the circulation.

In comparison to an ultrafiltration (dead-end operation or cross-flow operation), it is possible, for example, to attain higher dry substance contents and, in addition, the required back flush is less (in comparison to a dead flow) and the required energy is reduced (in comparison to a cross flow). In comparison to a conventional ultrafiltration, it is possible, for example, to achieve a higher permeate flow (per square meter of filter surface area), and, for example, the filtration capacity can be greater by an order of magnitude. The system can also be provided, for example, without prior sedimentation, that is, without the lamella separator upstream of the membrane filter system. This can result in a smaller surface area or spatial requirement and, for example, as such, can also promote more uniform conditions during the electrochemical machining. Especially in view of the preferred application in the manufacture of components for turbomachines, the latter can be advantageous (because of the high required precision).

Preferred embodiments are found in the dependent claims and in the entire disclosure, whereby, in the description of features, a distinction is not always made in detail between the different claim categories; in any case, the disclosure is to be read implicitly always in terms of method aspects as well as corresponding use aspects and device aspects. The disclosure is directed, on the one hand, at the machining method and, on the other hand, also implicitly at a corresponding unit with a machining unit for electrochemical machining and a membrane filter system.

The electrolyte liquid or electrolyte solution can also depend on the material of the workpiece, for example. Mentioned by way of example are aqueous solutions of sodium chloride or sodium nitrate. Regardless of the electrolyte liquid in detail, an electron current can be adjusted in the work gap during machining and brings about the dissolution of metal cations from the metal workpiece. Depending on the material, these cations can be, for example, Ni2+, Fe2+, Fe3+, Cr6+, etc. As a result of the electrochemical machining, the electrolyte can become contaminated by environmentally critical substances, for which reason, conversely, the limited process volume comes into effect advantageously. In view of safety measures, etc., it can be advantageous when a smaller volume of a potentially critical liquid needs to be handled. In general, the filtration occurs without additional chemicals; for example, no flocculants are added or need to be added.

Furthermore, it is also possible by way of the relative movement to achieve a relatively high concentration of the retentate, that is, of the components that have been filtered out, which can be advantageous in regard to the disposal thereof (see below in detail). Through a higher retentate concentration, it is also possible, for example, to attain a higher electrolyte yield; for example, the sludge can be preconditioned to a defined solids content, for example. This solids content can lie, for example, in a range of 10-25 wt %, preferably 15-20 wt %.

In accordance with a preferred embodiment, the membrane is provided in a disk shape, that is, is flat, in particular planar, and preferably with a circular contour. Independent of the disk shape, the membrane can also bound an inner space, preferably by two membrane walls that lie opposite to each other. Preferably, the electrolyte liquid is thereby fed from the outside to the inside; that is, the permeate is discharged over the inner space between the membrane walls. Also regardless of its shape, the provided membrane can be made from corundum, for example.

In a preferred embodiment, the membrane is mounted on a shaft, on which, during the filtration, it is rotated in order to bring about the relative movement. The membrane can hereby have, in particular, a disk shape, with a central axis of the disk coinciding with the axis of rotation of the shaft. As discussed below in detail, it is also possible to arrange on the shaft a plurality of membranes in an axial offset manner, in particular membranes that are identical in construction to one another in a translationally symmetrical manner. Alternatively to the rotation of the membrane, the relative movement in accordance with the main claim can also be realized in general by the use of, for example, a slider that, as viewed in a spatially fixed coordinate system, is moved along the membrane at rest.

In accordance with a preferred embodiment, the membrane filter system has a second membrane, which is arranged so as to overlap the first membrane. The membranes are moved relative to each other; to this end, the first membrane is arranged on the first shaft (see above) and the second membrane is arranged on a second shaft, which, as viewed in a spatially fixed coordinate system, is also rotated. The shafts hereby lie preferably parallel with respect to each other, whereby the partial overlap exists as viewed in the axial direction. In the spatially fixed coordinate system, the shafts and thus the axes of rotation are, in particular, vertical. Regardless of these details, the rotation occurs preferably in the same sense of rotation; that is, the shafts are rotated in the same direction of rotation.

In accordance with a preferred embodiment, the shafts are each furnished with a plurality of membranes, whereby the membranes of the shafts intermesh with each other in an axially alternating manner. Axially nearest-neighbor membranes of the one shaft thus each form an intermediate space in which a membrane of the other shaft intermeshes and vice versa. In general, the parallel operation makes it possible to increase the throughput and/or to optimize the construction size of the membrane filter system.

In accordance with a preferred embodiment, as viewed in the spatially fixed coordinate system, an inlet of the membrane filter system is arranged below and a retentate outlet is arranged above. Via the latter, the retentate that has been filtered out, which is typically still pumpable, that is, is not solid, is discharged. Regardless of this, the permeate can be discharged out of the inner space of the membrane or the inner spaces of the membranes via a channel in the shaft, for example, whereby, in the case of a vertical alignment, the removal must then occur preferably vertically below.

In a preferred embodiment, the retentate that has been filtered out in the membrane filter system is subsequently further concentrated, preferably in a press. It is hereby possible to provide, in particular, a membrane filter press, which, for example, can also be stored in a storage tank upstream of a further press. By way of the “prethickening” in the membrane filter system, the volume flow can be reduced; that is, in comparison to a conventional ultrafiltration, for instance, less pressing is required. The retentate that has been further concentrated is then preferably dried. This can be advantageous in terms of disposal. For example, only a solid with potentially critical components (reduced volume) then needs to be disposed of.

In accordance with a preferred embodiment, the workpiece that has been electrochemically machined is a component for a turbomachine, in particular for an aircraft engine. The component can be, for example, a rotating disk, in which, by removal of material, a blade root mount is introduced; alternatively, however, it is also possible to manufacture a blade root or else another component, in particular one that is then arranged in the gas channel.

The invention also relates to a machining device, which comprises a machining unit, a membrane filter system, and a feed device. In the machining device, the workpiece can be arranged and machined by electrochemical removal of material. In particular, it can have a machining cathode and a container in which the workpiece can be kept in the electrolyte liquid. In regard to possible details of the membrane filter system, reference is made to the preceding disclosure.

The feed unit supplies, on the one hand, the electrolyte liquid from the machining device to the membrane filter system, preferably via a dirt tank, in which the spent electrolyte liquid undergoes intervening storage in front of the filter. Furthermore, it then pumps the filtered electrolyte liquid, that is, the permeate, once again to the membrane filter system, preferably via a fresh tank. In the latter, the filtered electrolyte liquid can undergo intervening storage before it is once again fed to the machining device, that is, is used for electrochemical machining.

Between the fresh tank and the machining device, it is hereby possible to provide a safety filter so as, in any case, to prevent any input of solids into the machining device. The machining device can further have, as depicted above, a press, in particular a membrane filter press, and a dryer. Furthermore, it can comprise a control unit, which, for example, actuates the feed unit and the membrane filter system in combination with, for example, level sensors on the dirt tank and/or fresh tank.

### BRIEF DESCRIPTION OF THE DRAWINGS

The invention will be explained in detail below on the basis of an exemplary embodiment, whereby the individual features in the scope of the dependent claims can also be of essence to the invention in other combinations, and, moreover, no distinction is made in detail between the different claim categories.

Shown in detail are:

FIG. 1 shows a unit for electrochemically machining a workpiece, with a machining device and a membrane filter system;

FIG. 2 shows several method steps summarized in a flow chart;

FIG. 3 shows an axial turbomachine, namely, an aircraft engine, for illustration of a preferred area of application.

### DESCRIPTION OF THE INVENTION

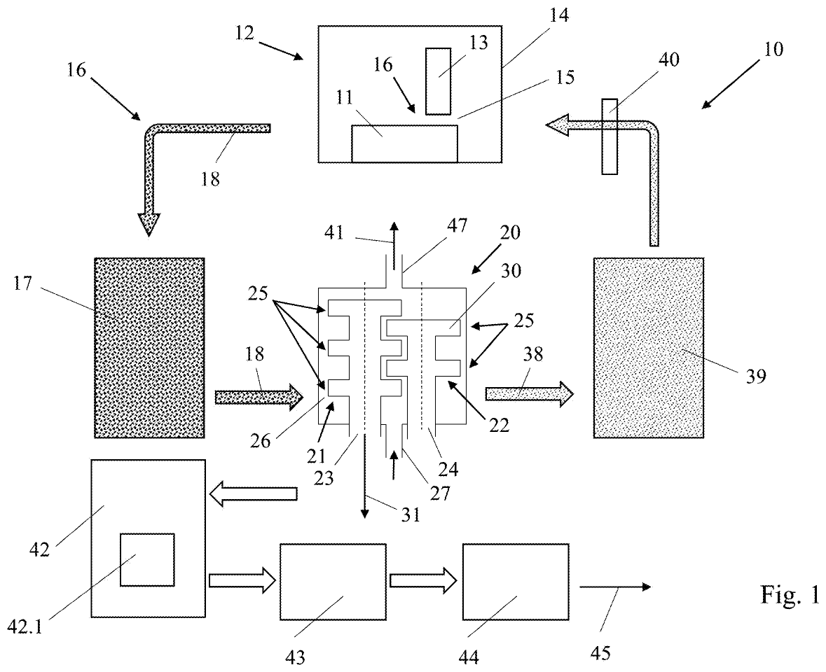

FIG. 1 shows a unit 10 for electrochemically machining a workpiece 11. The machining device 12 has a machining cathode 13 and a reservoir 14, in which the workpiece 11 is kept in an electrolyte liquid 15. An electron current is adjusted in a work gap 16 between the workpiece 11 and the machining cathode 13, as a result of which a dissolution of metal ions from the workpiece 11 is brought about. In the course of the removal of material, metal cations accumulate in the electrolyte liquid 15.

By a feed unit 16, the spent electrolyte liquid 15 is led out of the reservoir 14 to a membrane filter system 20. In the present case, this takes place via a dirt tank 17 and a corresponding piping 18. The membrane filter system 20 has a first membrane 21 and a second membrane 22, which are each formed in a disk shape and are rotatably mounted on a respective shaft 23, 24. Arranged on each of the shafts 23, 24 are a plurality of membranes 25, which follow one another axially and intermesh in one another with an overlap.

The electrolyte liquid 15 is fed to the membrane filter system 20, specifically to an inner space 26, in which the membranes 25 are arranged, via an inlet 27. The membranes 25 each bound, between two membrane walls, an inner space 30, in which the filtered electrolyte enters through the membrane walls. From there, the filtered electrolyte liquid can be discharged via the respective shaft 23, 24 as permeate 31. The shafts 23, 24 and thus the membranes 25 are rotated during the filtration and thus undergo relative movement with respect to each other, resulting in an effective tangential flow of the electrolyte liquid being filtered over the membrane walls.

The filtered electrolyte liquid, that is, the permeate 31, is fed via a piping 38 initially into a fresh tank 39 and then once again to the machining device 12. In order to prevent any entry of solids, a safety filter 40 is provided. The retentate 41 is withdrawn above at the membrane filter system 20 at a retentate outlet 47 and is fed via a filter tank 42 with a press 42.1 of a membrane filter press 43. Afterwards, it reaches a dryer 44 and the component that has been filtered out is disposed of as a solid.

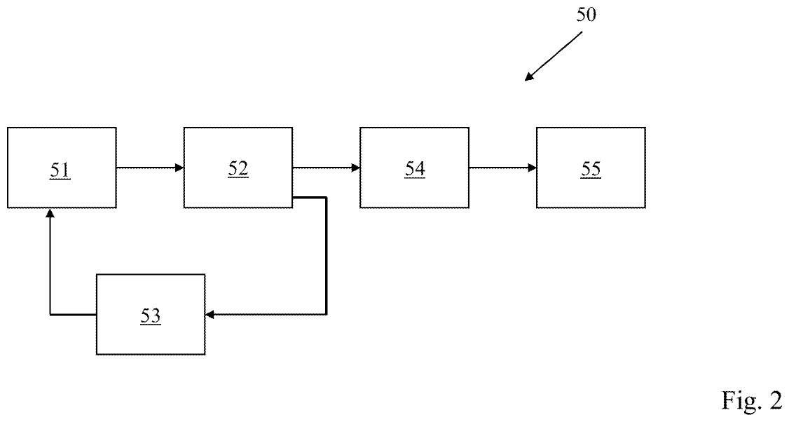

Summarized in FIG. 2 in a flow chart 50 are several method steps. In the machining device, the workpiece is electrochemically machined 51. The spent electrolyte liquid 15 is thereby subsequently filtered 52, whereby the permeate is once again fed 53 to the machining device 12. The retentate is pressed 54 and dried 55.

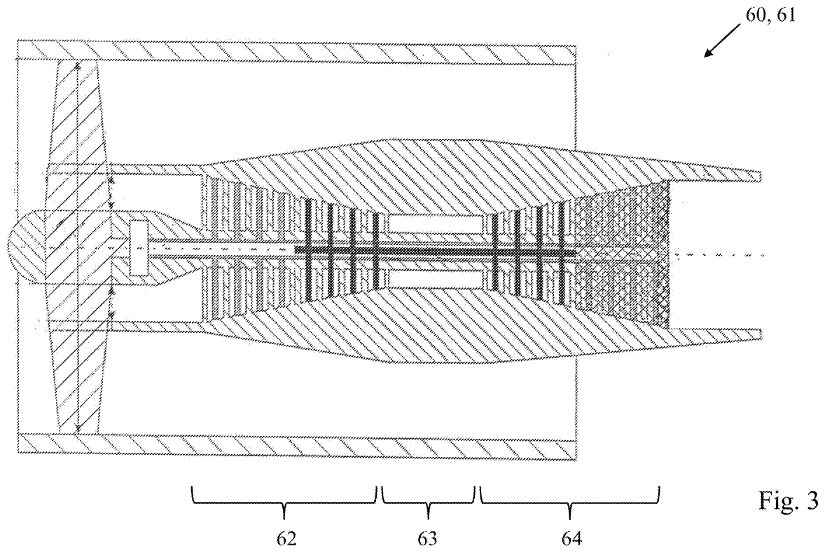

FIG. 3 shows an axial turbomachine 60, specifically an aircraft engine 61. It is divided functionally into a compressor 62, a combustion chamber 63, and a turbine 64, with both the compressor 62 and the turbine 64 being constructed from a plurality of stages (not referenced in detail), each of which has a stator and a rotor. In the compressor 62, air intake is compressed and then undergoes combustion with admixed kerosene in the combustion chamber 63. The hot gas that is formed is expanded in the turbine 64, whereby the kinetic energy obtained is used for driving the compressor 62 and for producing thrust.

1. A method for electrochemically machining a workpiece, comprising the steps of:
removing material from the workpiece in an electrolyte liquid,
filtering the electrolyte liquid in a membrane filter system to provide a filtered electrolyte liquid, the membrane filter system having a first membrane that undergoes relative movement in the membrane filter system during the step of filtering the electrolyte liquid,
using the filtered electrolyte liquid again for electrochemical machining.

2. The method according to claim 1, wherein the first membrane has a disk shape.

3. The method according to claim 1, wherein the membrane is mounted on a shaft and, during the filtration, is rotated as viewed in a spatially fixed coordinate system.

4. The method according to claim 1, wherein the membrane filter system has a second membrane, wherein the first membrane and the second membrane are arranged with an overlap and undergo relative movement with respect to each other.

5. The method according to claim 2, wherein the second membrane is arranged on a second shaft and is rotated as viewed in the spatially fixed coordinate system.

6. The method according to claim 5, wherein the shafts are each provided with a plurality of membranes, wherein the membranes of the shafts are arranged one after the other axially so as to overlap in an alternating manner.

7. The method according to claim 1, wherein, as viewed in a spatially fixed coordinate system, an inlet of the membrane filter system, via which the electrolyte liquid is fed, is arranged below, and a retentate outlet of the membrane filter system, via which a retentate that has been filtered out is discharged, is arranged above.

8. The method according to claim 1, wherein a retentate that has been filtered out by the membrane filter system is subsequently further concentrated in a press to provide a concentrated retentate.

9. The method according to claim 8, wherein the concentrated retentate is subsequently dried.

10. The method according to claim 1, wherein the workpiece is a component for a turbomachine.

11. A unit for electrochemically machining a workpiece, comprising:
a machining device for arranging the workpiece and for removing material from the workpiece in an electrolyte liquid,
a membrane filter system, which has a membrane and is configured and arranged for relative movement of the membrane during the filtration,
a feed unit which is configured and arranged to feed the electrolyte liquid to the membrane filter system from the machining device and then to feed the filtered electrolyte liquid once again to the machining device.

12. The unit according to claim 11 being configured and arranged for carrying out the method according to claim 1.

13. The method according to claim 4, wherein the second membrane is arranged on a second shaft and is rotated as viewed in the spatially fixed coordinate system.
